(19) United States
(12) Patent Application Publication
(10) Pub. No.: US 2023/0419062 A1
(43) Pub. Date: Dec. 28, 2023

(54) SYSTEMS, METHODS, AND APPARATUSES FOR DETERMINATION OF AN AVAILABILITY OF A RESOURCE IN A SPECIFIC ENTITY NETWORK

(71) Applicant: BANK OF AMERICA CORPORATION, Charlotte, NC (US)

(72) Inventors: Kathleen Hanko Trombley, Oakboro, NC (US); Heather Roseann Dolan, Sarasota, FL (US)

(73) Assignee: BANK OF AMERICA CORPORATION, Charlotte, NC (US)

(21) Appl. No.: 17/849,909

(22) Filed: Jun. 27, 2022

(51) Int. Cl. G06K 7/14; G06Q 10/08

(52) U.S. Cl. CPC G06K 7/1404; G06Q 10/087

(57) ABSTRACT

Systems, apparatuses, and methods are described herein to determine an availability of a resource in a specific entity network. The present invention is configured to determine the availability of a resource in a specific entity network by identifying a specific entity location associated with a user device, by scanning a readable indicia to identify a resource identifier associated with a specific entity, and by determining a physical unavailability of a resource associated with the resource identifier within the specific entity location. The present invention is further configured to determine a location of the resource to be at a different location from the specific entity location, to determine a period for the resource associated with the resource identifier to reach a geolocation identified by a user of the system, and to generate an availability of the resource user interface component to configure a graphical user interface of the user device.

### FIELD OF THE INVENTION

The present invention embraces a system for systems, methods, and apparatuses for determination of an availability of a resource in a specific entity network.

### BACKGROUND

Users of a specific entity network, such as consumers using a specific entity's various locations (e.g., store locations, warehouse locations, manufacturing locations, and/or the like) have a harder time than ever tracking the availability of resources within the specific entity's network. For instance, in today's environment of supply chain issues and manufacturing delays, consumers have a difficult time finding available inventory of resources (e.g., products) that the user may need and, instead the consumers are only met with empty shelves and questions of when the resources will be restocked or available for purchase. In addition to these supply chain issues, consumers face the problem of once they do find the available resources in their stores, the value and/or cost of the resource may have increased exponentially, such as an increase due to inflation and other manufacturing or shipping costs. Specifically, there exists a need to track available resources in a specific entity's entire network, not just nearby specific entity locations that the user may be within range to visit, a need to track real-time updates to the resource inventory, and a need to determine the amount of time it will take for a resource to become available (e.g., shipped) to the user and/or a user-selected geolocation.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for determining an availability of a resource in a specific entity network, the system comprising: a memory device with computer-readable program code stored thereon; at least one processing device operatively coupled to the at least one memory device and the at least one communication device, wherein executing the computer-readable code is configured to cause the at least one processing device to: identify a specific entity location associated with a user device; scan readable indicia to identify a resource identifier associated with a specific entity; determine a physical unavailability of a resource associated with the resource identifier within the specific entity location; determine a location of the resource to be at a different location from the specific entity location; determine a period for the resource associated with the resource identifier to reach a geolocation identified by a user of the system; and generate, in response to the determination of the resource at the different location from the specific entity location, an availability of the resource user interface component to configure a graphical user interface of the user device.

In some embodiments, the processing device is further configured to: generate a period interface component to configure the graphical user interface of the user device, the period interface component comprising data of the period for the resource associated with the resource identifier to reach the geolocation identified by the user. In some embodiments, the geolocation identified by the user comprises at least one of a user's residential location, the location associated with the user device, or a shipping location identified by the user.

In some embodiments, the determination of the period for the resource associated with the resource identifier to reach the geolocation identified by the user comprises querying a resource database of the specific entity to determine a current availability of a plurality of objects associated with the resource identifier.

In some embodiments, the geolocation identified by the user is the specific entity location associated with the user device.

In some embodiments, the processing device is further configured to: receive, from the user device, an indication of a request for a real-time resource transaction, the real-time resource transaction comprising a real-time value of the resource; and complete the request for the real-time resource transaction.

In some embodiments, the processing device is further configured to: receive a plurality of values associated with the resource, the plurality of values based on a plurality of geolocations comprising an object associated with the resource; identify a lowest-value of the plurality of values associated with the resource; and generate, in response to the identification of the lowest-value of the plurality of values associated with the resource, a lowest-value interface component to configure the graphical user interface of the user device.

In some embodiments, the processing device is further configured to: determine, based on the identification of the resource identifier, a specified entity resource geolocation to be within the specific entity location, the specified entity resource geolocation comprising at least one of a specified aisle, a specified shelf, or a specified department within the specific entity location; and generate, in response to the determination of the specified entity resource geolocation, a specified entity resource geolocation interface component to configure the graphical user interface of the user device. In some embodiments, the processing device is further configured to: identify a real-time resource amount within the specific entity location, wherein the real-time resource amount is based on real-time inventory tracker data of the resource within the specific entity location; and dynamically update the specified entity resource geolocation interface component with the real-time inventory tracker data.

In some embodiments, the processing device is further configured to: generate a transaction completion interface component to configure the graphical user interface of the user device; receive, from the user device, an indication of a plurality of resources as potential resources to purchase; and automatically add the indication of the plurality of resources as potential resources to purchase to the transaction completion interface component.

In some embodiments, the processing device is further configured to: generate, in response to the determination that the location of the resource to be at the location different from the specific entity location, a general entity resource geolocation interface component to configure the graphical user interface of the user device.

In another aspect, a computer program product for determining an availability of a resource in a specific entity network, wherein the computer program product comprises at least one non-transitory computer-readable medium having computer-readable program code portions embodied therein, the computer-readable program code portions which when executed by a processing device are configured to cause the processor to: identify a specific entity location associated with a user device; scan readable indicia to identify a resource identifier associated with a specific entity; determine a physical unavailability of a resource associated with the resource identifier within the specific entity location; determine a location of the resource to be at a different location from the specific entity location; determine a period for the resource associated with the resource identifier to reach a geolocation identified by a user of the system; and generate, in response to the determination of the resource at the different location from the specific entity location, an availability of the resource user interface component to configure a graphical user interface of the user device.

In some embodiments, the processing device is further configured to cause the processor to generate a period interface component to configure the graphical user interface of the user device, the period interface component comprising data of the period for the resource associated with the resource identifier to reach the geolocation identified by the user.

In some embodiments, the geolocation identified by the user comprises at least one of a user's residential location, the location associated with the user device, or a shipping location identified by the user.

In some embodiments, the determination of the period for the resource associated with the resource identifier to reach the geolocation identified by the user comprises querying a resource database of the specific entity to determine a current availability of a plurality of objects associated with the resource identifier.

In some embodiments, the processing device is further configured to cause the processor to: receive, from the user device, an indication of a request for a real-time resource transaction, the real-time resource transaction comprising a real-time value of the resource; and complete the request for the real-time resource transaction.

In another aspect, a computer-implemented method for determining an availability of a resource in a specific entity network, the computer-implemented method comprising: identifying a specific entity location associated with a user device; scanning readable indicia to identify a resource identifier associated with a specific entity; determining a physical unavailability of a resource associated with the resource identifier within the specific entity location; determining a location of the resource to be at a different location from the specific entity location; determining a period for the resource associated with the resource identifier to reach a geolocation identified by a user of the system; and generating, in response to the determination of the resource at the different location from the specific entity location, an availability of the resource user interface component to configure a graphical user interface of the user device.

In some embodiments, the computer-implemented method further comprises generating a period interface component to configure the graphical user interface of the user device, the period interface component comprising data of the period for the resource associated with the resource identifier to reach the geolocation identified by the user.

In some embodiments, the geolocation identified by the user comprises at least one of a user's residential location, the location associated with the user device, or a shipping location identified by the user.

In some embodiments, the determination of the period for the resource associated with the resource identifier to reach the geolocation identified by the user comprises querying a resource database of the specific entity to determine current availability of a plurality of objects associated with the resource identifier.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for determination of an availability of a resource in a specific entity network, in accordance with an embodiment of the invention.

FIG. 2 illustrates a process flow for determining an availability of a resource in a specific entity network, and specifically for generating an availability of the resource interface component to configure a graphical user interface of a user device, in accordance with an embodiment of the invention.

FIG. 3 illustrates a process flow for generating a period interface component to configure the graphical user interface of the user device, in accordance with an embodiment of the invention.

FIG. 4 illustrates a process flow for generating a specified entity resource geolocation interface component to configure the graphical user interface of the user device, in accordance with an embodiment of the invention.

FIG. 5 illustrates a process flow for generating a general entity resource geolocation interface component to configure the graphical user interface of the user device, in accordance with an embodiment of the invention.

FIG. 6 illustrates a process flow for completing the request for the real-time resource transaction, in accordance with an embodiment of the invention.

FIG. 7 illustrates a process flow for generating a lowest-value interface component to configure the graphical user interface of the user device, in accordance with an embodiment of the invention.

FIG. 8 illustrates a process flow for dynamically updating the specified entity resource geolocation interface component with the real-time inventory tracker data, in accordance with an embodiment of the invention.

FIG. 9 illustrates a process flow for automatically adding the indication of the plurality of resources as potential resources to purchase to the transaction completion interface component, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, a “specific entity” may be an institution employing information technology resources and/or providing resources to consumers (e.g., products). Typically, this data can be related to the people who work for the organization, its products (e.g., resources) or services, the customers or any other aspect of the operations of the organization. As such, the specific entity may be any institution, group, association, financial institution, establishment, company, chain of stores, union, authority or the like, employing information technology resources for processing large amounts of data and/or acting as a merchant for a plurality of resources.

As described herein, a “user” may be an individual associated with the specific entity. As such, in some embodiments, the user may be an individual having past relationships, current relationships, or potential future relationships with a specific entity—such as a past consumer of the specific entity, a current consumer of the specific entity, or a future consumer of the specific entity. In some embodiments, the user may be an employee (e.g., an associate, a project manager, an IT specialist, a manager, an administrator, an internal operations analyst, or the like) of the specific entity or enterprises affiliated with the specific entity.

As used herein, a “user interface” may be a point of human-computer interaction and communication in a device (e.g., a user device) that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity, such as a specific entity. In some example implementations, a resource may be associated with one or more accounts or may be property that is not associated with a specific account. Examples of resources associated with specific entities may be resources that have cash or cash equivalents, commodities, and/or accounts that are funded with or contain property, like a consumer product offered for sale such as jewelry, art or other valuables, a resource that is funded with property, or the like.

As used herein, a “resource identifier” may generally refer to one or more data elements by which a resource associated with the specific entity and/or resource availability system may be uniquely identified. The resource identifier may include, without limitation, a unique series of numbers, symbols, and/or alphabetical characters; a location of the resource; a model-name of the resource; a natural name (e.g., a name of the product known by consumers); and/or the like. The resource identifier may include, for example, numerical characters, alphabetical characters, alphanumeric codes, American Standard Code for Information Interchange (ASCII) characters, identification certificates, the like, or combinations thereof. The resource identifier may be associated with a resource within a resource availability system. For purposes of this invention, a resource identifier is typically stored in a specific entity's database or repository—a storage location where one or more resource identifiers are organized, stored and retrieved electronically using a computing device. In some embodiments, the specific entity's database may further store locations and inventory tracking of the plurality of resources associated with the resource identifiers, such as within a resource database.

As used herein, a “resource transaction,” “resource transfer,” “resource distribution,” or “resource allocation” may refer to any transaction, activities or communication between one or more entities, or between the user and the one or more entities. A resource transaction may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “resource transaction”, a “transaction event” or a “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

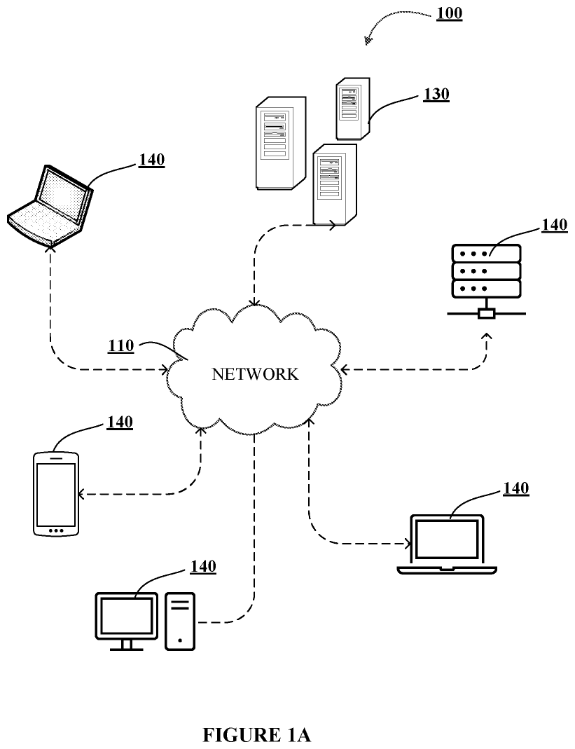

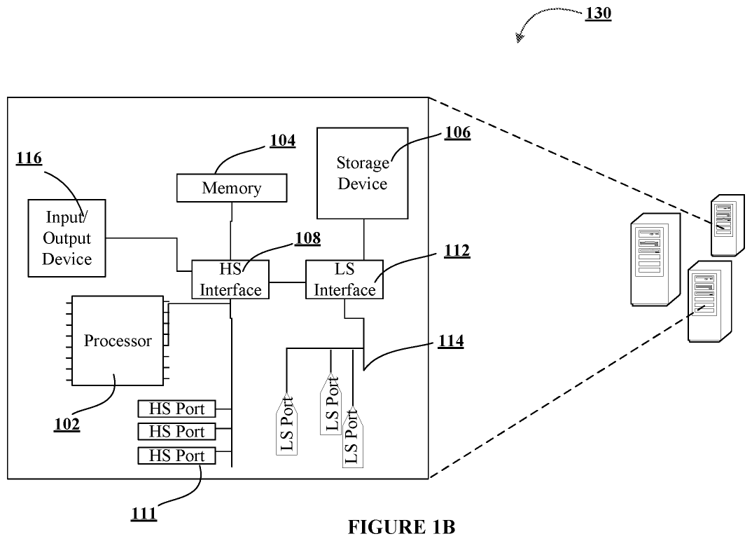

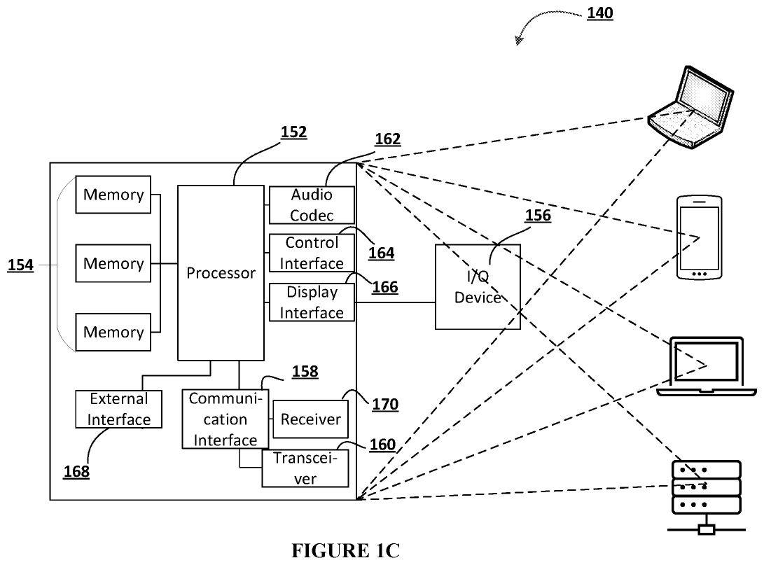

As described in further detail herein, the present invention provides a solution to the above-referenced problems in the field of technology by generating an accurate, efficient, and real-time update of the user device's graphical user interface with various interface components showing the availability of resources throughout a specific entity's network and by providing a mechanism to complete a resource transaction in real-time based on resource availability. The present invention solves this technical problem by implementing a resource availability system, like that shown as system 130 in FIGS. 1A-1C. For instance, the resource availability system acts to identify resources, such as by using a scannable indica and location tracking of a user device, a resource identifier and a specific entity location that the user device is current located, and whether the specific entity location has in inventory of the resource associated with the resource identifier. If, in fact, the specific entity location does not have the resource in inventory, either in the specified location where the user device is current (e.g., the specified department, self, or aisle), then the resource availability system may determine where else in the specific entity location the resource is in inventory and/or where else in different specific entity locations (e.g., different stores than the specific entity location of the user device) the resource is inventory. If the resource is in inventory only in different specific entity locations, then the resource availability system may generate an interface component to configure the graphical user interface (GUI) of the user's device to show where, in the different specific entity locations, the resource is available. Additionally, and/or alternatively, the resource availability system may also receive a geolocation input by the user to show where the user wishes the resource to be sent when it is determined as available (e.g., the user's residential address, a different user's address, or the current store the user device is currently located) and the resource availability system may determine a period of time it will take the resource to be shipped to the geolocation identified by the user.

Accordingly, the resource availability system works by identifying a specific entity location associated with a user device by scanning a readable indicia to identify a resource identifier associated with a specific entity; by determining a physical unavailability of a resource associated with the resource identifier within the specific entity location; by determining a location of the resource to be in a different location from the specific entity location; determining a period for the resource associated with the resource identifier to reach a geolocation identified by the a user of the system; and generating, in response to the determination of the resource at the different location from the specific entity location, an availability of the resource user interface component to configure the graphical user interface of the user device.

What is more, the present invention provides a technical solution to a technical problem. As described herein, the technical problem includes the failure of prior systems to accurately and efficiently identify whether a resource is available in a specific entity's network, including the need for real-time tracking of inventory in the specific entity's various specific entity locations, and tracking of data regarding the time it will take for the resource to reach a user-identified geolocation. The technical solution presented herein allows for resource availability system to accurately and efficiently identify resources in a specific entity network, identify inventory data of each resource in the specific entity network (including real-time data), and generate interface components to allow resource transactions to be completed in real-time based on an availability of resources in the specific entity network as a whole and based on the period of time it will take for the resource to be transported to a user-identified geolocation. In particular, resource availability system is an improvement over existing solutions to the tracking and real-time inventorying of resources in an entity's network (i) with fewer steps to achieve the solution, thus reducing the amount of computing resources, such as processing resources, storage resources, network resources, and/or the like that are being used (e.g., by implementing the resource availability system, which has a centralized resource database which is updated in real-time, the resource availability system may reduce the amount of computing resources that may have previously required each individual specific entity location to update and manage its own resource database); (ii) providing a more accurate solution to problem, thus reducing the number of sources required to remedy any errors made due to a less accurate solution (e.g., remedies being backwards tracking and updating of resource inventory tracking); (iii) removing manual input and waste from the implementation of the solution, thus improving speed and efficiency of the process and conserving computing resources (e.g., by allowing the removal of manual input by the user and, instead, allowing the scanning of readable indicia to automatically identify resource identifiers and associated resources in a specific entity network and the real-time inventory of the resource based on an automated tracking of the inventory, the system removes manual input and waste from implementation of the solution); (iv) determining an optimal amount of resources that need to be used to implement the solution, thus reducing network traffic and load on existing computing resources (e.g., the resource availability system may identify a resource at a closest location to the user, either at the specific entity location and/or to the user's identified geolocation, and may choose this resource to be shipped based on its ability to be transmitted using less shipping and computing resources than a resource at a greater distance). Furthermore, the technical solution described herein uses a rigorous, computerized process to perform specific tasks and/or activities that were not previously performed. In specific implementations, the technical solution bypasses a series of steps previously implemented, thus further conserving computing resources.

FIGS. 1A-1C illustrate technical components of an exemplary distributed computing environment for determining an availability of a resource in a specific entity network 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 (shown in FIG. 1B as “HS Interface”) connecting to the memory 104, and a low-speed interface 112 (shown in FIG. 1B as “LS Interface”) connecting to low speed bus 114 (shown in FIG. 1B as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111 (shown in FIG. 1B as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

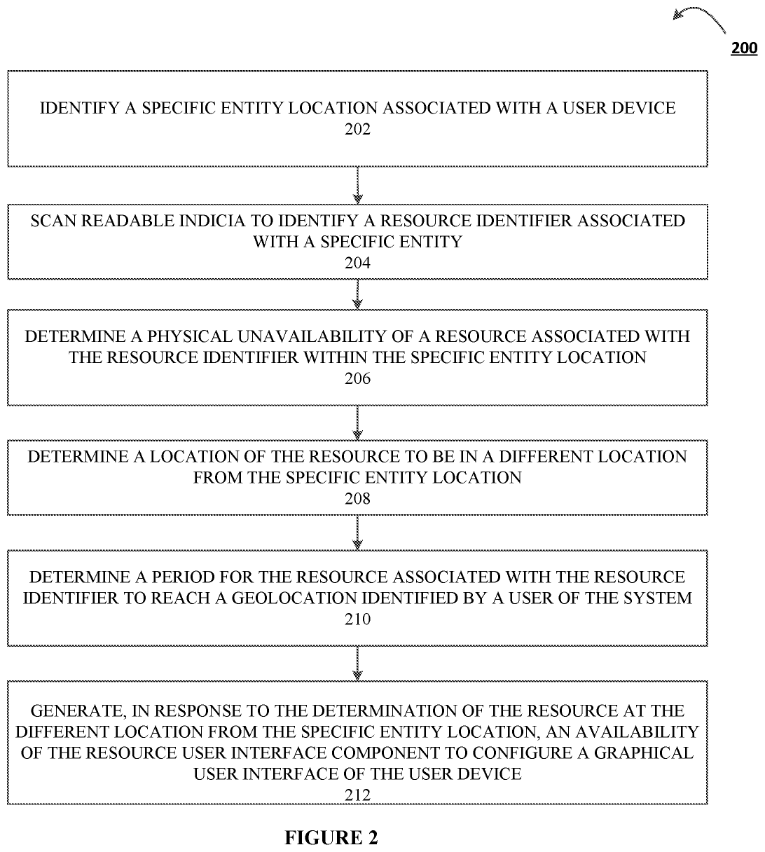

FIG. 2 illustrates a process flow 200 for determining an availability of a resource in a specific entity network, specifically comprising the generation of an availability of a resource user interface component to configure a graphical user interface of a user device, in accordance with an embodiment of the invention. In some embodiments, a system (e.g., similar to one or more of the systems described herein with respect to FIGS. 1A-1C) may perform one or more of the steps of process flow 200. For example, a resource availability system (e.g., the system 130 described herein with respect to FIG. 1A-1C) may perform the steps of process 200.

As shown in block 202, the process flow 200 may include the step of identifying a specific entity location associated with a user device. In some embodiments, the resource availability system may identify a specific entity location based on a geolocation of the user device. For instance, the user device (e.g., a device associated with a user of the system) may be tracked by geolocation data provided by a geographic tracker such as a built-in GPS within the user device, the connected network of the user device (e.g., such as a specific entity location's network), and/or user-input geolocation identifier (e.g., such as a specific entity location identified by zip code, address, city/town, specific entity location identifier like a store code, and/or the like).

As shown in block 204, the process flow 200 may include the step of scanning readable indicia to identify a resource identifier associated with a specific entity. In some embodiments, the user device may use an imaging device such as a camera, which may be a built-in camera within the user device and/or a camera separate from the user device. In some embodiments, the readable indicia may comprise computer-readable indicia such as a barcode, a series of numbers such as binary numbers, a series of alphanumeric symbols, a series of alphabetical characters, a series of lines or dashes, and/or the like or a human-readable indicia such as words and/or alphabetical letters in a human-readable stream (e.g., sentences or individual words).

In some embodiments, the user device may be configured to accept user-input as the readable indicia, such that scanning the readable indicia is not required by the resource availability system. For instance, the resource availability system may configure the GUI of the user device and request input by the user of the readable indicia (e.g., either computer-readable indicia and/or human-readable indicia) in order to identify a resource identifier. For instance, the user can manually input, into the resource availability system's configuration of the GUI a series of numbers such as binary numbers, a series of alphanumeric symbols, a series of alphabetical characters, a series of lines or dashes, human-readable text, and/or the like so the resource availability system may identify the resource identifier.

By way of non-limiting example, the readable indicia may be linked and/or identified by the resource availability system as being associated with a resource identifier. Such a linkage/identification to the resource identifier may be based on a query of a resource database stored in the resource availability system, such as storage device 106. By way of non-limiting example, once the resource identifier has been identified by the resource availability system, the resource (e.g., a product identified by the resource identifier, wherein the product is manufactured and/or sold by the specific entity at a plurality of specific entity locations) associated with the resource identifier is also identified by way of the resource identifier.

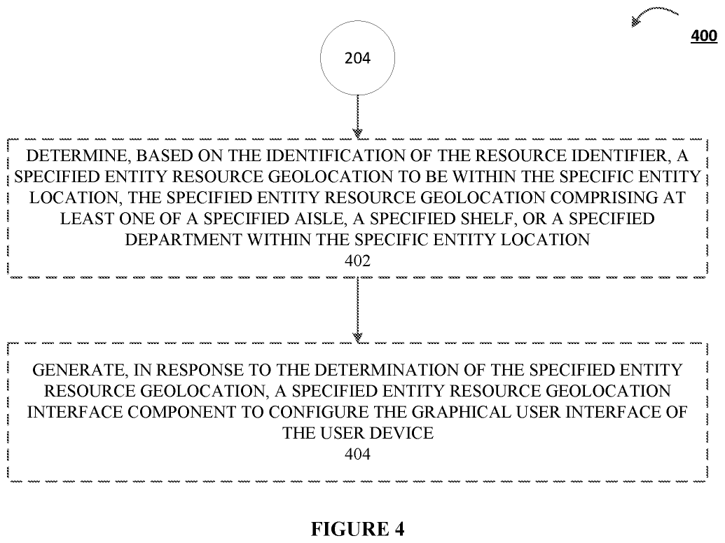

In some embodiments, once the resource identifier has been identified, the resource availability system may use the resource identifier to identify the locations where the resource is located, such as a plurality of specific entity locations. For instance, the resource identifier may be used to identify products (e.g., products of the same resource) associated with the identified resource and their specific locations within a plurality of stores associated with the specific entity, such as specific entity locations that have the resource in inventory. The identification of resources within the specific entity location associated with the user device is described in further detail with respect to FIG. 4.

As shown in block 206, the process flow 200 may include the step of determining a physical unavailability of a resource associated with the resource identifier within the specific entity location. In some embodiments, the physical unavailability of the resource associated with the resource identifier may indicate a lack of the resource within a specific entity location, which may include a lack of the resource in a specific location of the specific entity location (e.g., the location associated with the particular readable indica such as a shelf the readable indicia is attached to and/or adjacent to) and/or a lack of resource in the entirety of the specific entity location associated with the user device (e.g., the specific entity location the user device is located in), where the resource is not in inventory at all in the specific entity location.

As shown in block 208, the process flow 200 may include the step of determining a location of the resource to be in a different location from the specific entity location. In some embodiments, the determination of the location of the resource within the specific entity location may be based on an inventory tracking within the specific entity location associated with the user device. By way of non-limiting example, the resource availability system may use the resource identifier associated with the resource to query a resource database of the specific entity in order to identify an amount of the resource in each specific entity location currently has (e.g., specific stores associated with a specific entity, specific warehouses associated with the specific entity, specific manufacturer warehouses associated with the specific entity including manufacturers the specific entity has access to, and/or the like).

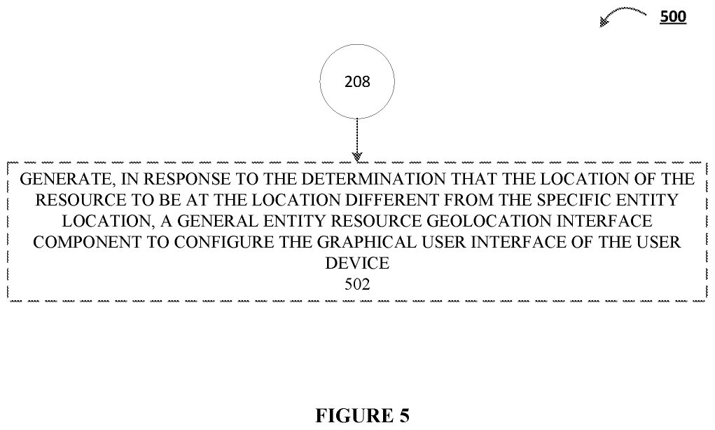

In some embodiments, the determination of the location of the resource to be in a different location from the specific entity location may be based on inventory tracking of the specific entity location associated with the user device and/or the inventory tracking of different specific entity locations within a certain distance to the specific entity location associated with the user device. For instance, if the inventory tracking of the specific entity location associated with the user device (i.e., the specific entity location where the user device is currently) returns an indication that the resource is not in inventory, then the resource availability system may track the inventory of different specific entity locations at a certain distance to the specific entity location associated with the user device, such as specific entity locations nearby (e.g., within the same city, town, state, region of country, country, and/or the like). The identification of the resource in a different specific entity location than the user device location and the interface component indicating the data of the different specific entity location is described in further detail with respect to FIG. 5.

As shown in block 210, the process flow 200 may include the step of determining a period (e.g., an amount of time) for the resource associated with the resource identifier to reach a geolocation identified by a user of the system. In some embodiments, the period for the resource associated with the resource identifier to reach a geolocation identified by the user of the system may be based on a distance between the current geolocation of the resource and the geolocation identified by the user. Additionally, or alternatively, the period for the resource to reach a geolocation identified by the user may be based on the shipping method, such as a ground shipping (e.g., by car, truck, train, and/or the like), by flight (e.g., by plane), and/or ship.

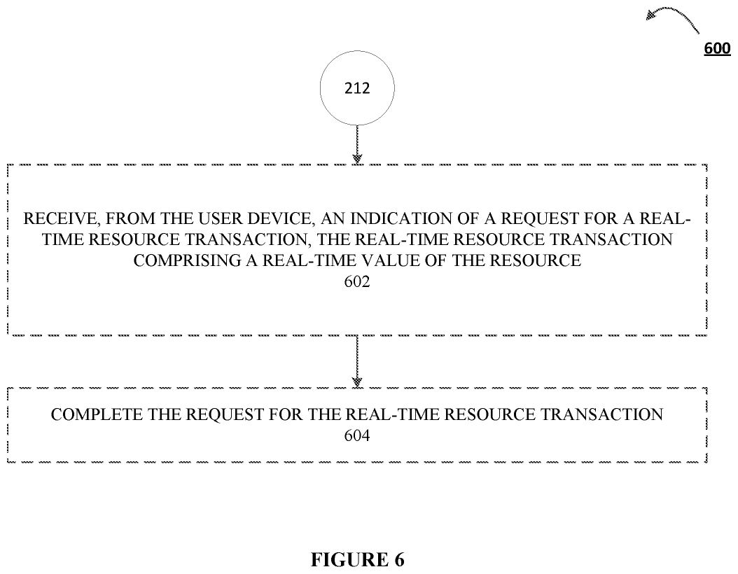

In some embodiments, the current geolocation of the resource may be identified by the resource availability system as the nearest resource to the geolocation identified by the user (e.g., the nearest specific entity location comprising the resource in its inventory). In this manner, the resource availability system may automatically choose the nearest resource to the user-identified geolocation for shipping to the user-identified geolocation in order to select the most efficient means of transport for the resource (e.g., the closest resource requires less travel and less travel resources expended). In some embodiments, the current geolocation of the resource may be selected by the user during a resource transaction, such as that described in further detail with respect to FIG. 6. In some embodiments, the resource availability system may determine the current geolocation of the resource based on a pre-determined selection by a manager of the resource availability system (which may identify a specific entity location such as a warehouse for which the resource should always be shipped from when there is an inventory of the resource available).

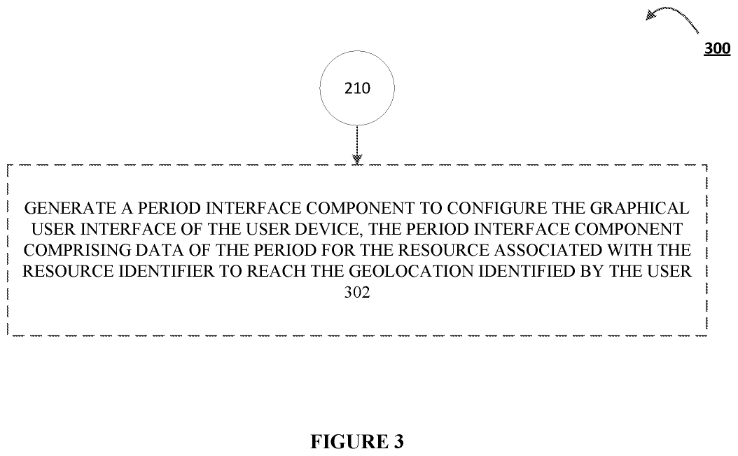

As shown in block 212, the process flow 200 may include the step of generating, in response to the determination of the resource at the different location from the specific entity location, an availability of the resource user interface component to configure a graphical user interface of the user device. By way of non-limiting example, the availability of the resource generally refers to data that shows where the resource is located (e.g., where the resource is in inventory in specific entity locations). In some embodiments, this data may indicate a particular specific entity location by zip code, address, city, town specific entity location code (e.g., a store code used as a store identifier), and/or the like. In some embodiments, the availability of the resource interface component may comprise the data of the availability of the resource in a user-readable format, which may be rendered by way of computer-readable code. Once the availability of the resource user interface component has been generated by the resource availability system, the resource availability system may transmit the availability of the resource user interface component to the user device over a network (such as network 110) to configure the GUI of the user device. Additional or alternative embodiments with respect to user interface components used to configure the GUI of the user device are discussed in further detail with respect to at least FIGS. 3, 4, 6, 7, 8, and 9.

FIG. 3 illustrates a process flow 300 for generating a period interface component to configure the graphical user interface of the user device, in accordance with an embodiment of the invention. In some embodiments, a system (e.g., similar to one or more of the systems described herein with respect to FIGS. 1A-1C) may perform one or more of the steps of process flow 300. For example, a resource availability system (e.g., the system 130 described herein with respect to FIG. 1A-1C) may perform the steps of process 300.

As shown in block 302, the process flow 300 may include the step of generating a period interface component to configure the graphical user interface of the user device, the period interface component comprising data of the period for the resource associated with the resource identifier to reach the geolocation identified by the user. In some embodiments, the process flow 300, and specifically block 302 may flow directly from block 210 of the process flow 200. By way of non-limiting example, the period interface component, by way of the configured user device GUI, may show an amount of time it will take the resource at the current location to travel to the geolocation identified by the user. Such a period interface component may indicate an amount of time in months, weeks, days, hours, minutes, seconds, and/or the like that is an estimated amount of time the resource in a different specific entity location will take to get to the specific entity location associated with the user device and/or a different geolocation identified by the user. In some embodiments, the period interface component may indicate a specific day and time the resource should arrive at the geolocation identified by the user instead of a countdown.

In some embodiments, the period interface component may indicate a plurality of resources (e.g., a plurality of products associated with a single resource identifier) from a plurality of current locations along with their associated periods to reach the geolocation identified by the user. For instance, the period user interface component may show a user a plurality of different periods, wherein each period indicates an amount of time for each resource associated with the resource identifier, to reach the geolocation identified by the user such that the user may select a specific resource based on a desired arrival time (e.g., the user may wish for the resource to reach the geolocation identified by the user at a specific time and/or specific day). In some embodiments, the period interface component may be used in conjunction with the availability of the resource user interface component of block 212 to configure the GUI of the user device. In some other embodiments, the period interface component may be used on its own to configure the GUI of the user device.

In some embodiments, the user may select the geolocation identified by the user to be the user's residential location (e.g., home address and/or office address), the location associated with the user device (e.g., the location of the user device at its current location in the specific entity location), and/or a shipping location identified by the user (e.g., an address identified by the user that is different than the user's residential location or the current location of the user device, such as a different specific entity location—a different store—or a different user's residential location, such as a family member or friend's residential location).

By way of non-limiting example, the geolocation identified by the user may be received by the resource availability system from the user's device by way of an indication input into the user device's GUI which is configured by the resource availability system to accept such data. For instance, a user may select from certain locations preloaded into the user interface (such as their own address, the specific/current store's address, or a different store in the same general area) or the geolocation identified by the user may be based on a different address input by the user such as a friend or family member's address located away from the store, which may include a different zip code, a different town, a different city, a state, or a different country.

FIG. 4 illustrates a process flow 400 for generating a specified entity resource geolocation interface component to configure the graphical user interface of the user device, in accordance with an embodiment of the invention. In some embodiments, a system (e.g., similar to one or more of the systems described herein with respect to FIGS. 1A-1C) may perform one or more of the steps of process flow 400. For example, a resource availability system (e.g., the system 130 described herein with respect to FIG. 1A-1C) may perform the steps of process 400.

As shown in block 402, the process flow 400 may include the step of determining, based on the identification of the resource identifier, a specified entity resource geolocation to be within the specific entity location, the specified entity resource geolocation comprising at least one of a specified aisle, a specified shelf, or a specified department within the specific entity location. In some embodiments, the resource availability system may determine that the resource is within the inventory of the specific entity location associated with the user device (i.e., the specific entity location that the user device is currently located) and, further, may identify a specified location (e.g., a specified aisle, a specified shelf, and/or a specified department) within the specific entity location that the resource is in inventory. Such a specified location may be identified by the resource availability system based on a current inventory of the resources (e.g., the products associated with the resource identifier) within the specific entity location and whether there are resources currently within the specific entity location. By way of non-limiting example, the specified aisle may comprise a specific aisle in the specific entity location, the specified shelf may comprise a specific shelf within the specific entity location, and the specified department may comprise a specific department or a specific group of shelves in a specific entity location.

In some embodiments, this specified entity resource geolocation may indicate a specified aisle, a specified shelf, and/or a different specific entity location (e.g., a different specific entity location than the one the user device is located currently) and may further indicate a specified aisle, a specified shelf, and/or a specified department in the different specific entity location.

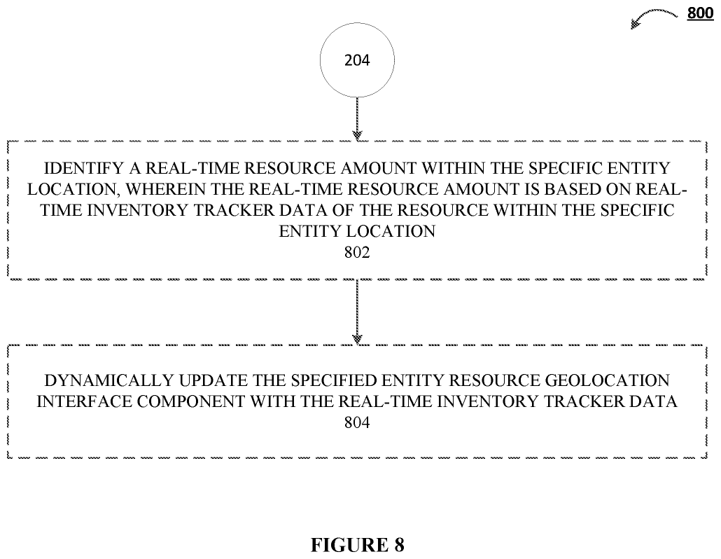

As shown in block 404, the process flow 400 may include the step of generating, in response to the determination of the specified entity resource geolocation, a specified entity resource geolocation interface component to configure the graphical user interface of device associated with the user of the system. By way of non-limiting example, the specified entity resource geolocation interface component may comprise the data regarding the specified entity resource geolocation of the resource, which may indicate that the resource is in inventory in the specific entity location associated with the user device or a different specific entity location. In some embodiments, the specified entity resource geolocation interface component may then be transmitted by the resource availability system to the user device to configure the GUI of the user device. Additional, or alternative, embodiments with respect to the specified entity resource geolocation interface component are described in further detail herein, specifically with respect to FIG. 8.

FIG. 5 illustrates a process flow 500 for generating a general entity resource geolocation interface component to configure the graphical user interface of the user device, in accordance with an embodiment of the invention. In some embodiments, a system (e.g., similar to one or more of the systems described herein with respect to FIGS. 1A-1C) may perform one or more of the steps of process flow 500. For example, a resource availability system (e.g., the system 130 described herein with respect to FIG. 1A-1C) may perform the steps of process 500.

As shown in block 502, the process flow 500 may include the step of generating, in response to the determination that the location of the resource to be at the location different from the specific entity location, a general entity resource geolocation interface of the device associated with the user of the system. By way of non-limiting example, the general entity resource geolocation may generally refer to the location of the resource (i.e., product(s) associated with the resource identifier being in a different specific entity location than the specific entity location associated with the user device). In some embodiments, the process of block 502 may follow directly from the process described in block 208 of process flow 200.

In some embodiments, the general entity resource geolocation interface component may be used in conjunction with the availability of the resource user interface component of block 212, and/or the period interface component of block 302. By way of non-limiting example, even where the resource is identified as being in inventory in the specific entity location (i.e., the specific entity location associated with the user device), the availability of the resource user interface component may identify where the resource is in the specific entity location and configure the user device's GUI as such, the user device's GUI may further be configured by the general entity resource geolocation interface component to show the resources in different specific entity locations.

FIG. 6 illustrates a process flow 600 for completing the request for the real-time resource transaction, in accordance with an embodiment of the invention. In some embodiments, a system (e.g., similar to one or more of the systems described herein with respect to FIGS. 1A-1C) may perform one or more of the steps of process flow 600. For example, a resource availability system (e.g., the system 130 described herein with respect to FIG. 1A-1C) may perform the steps of process 600.

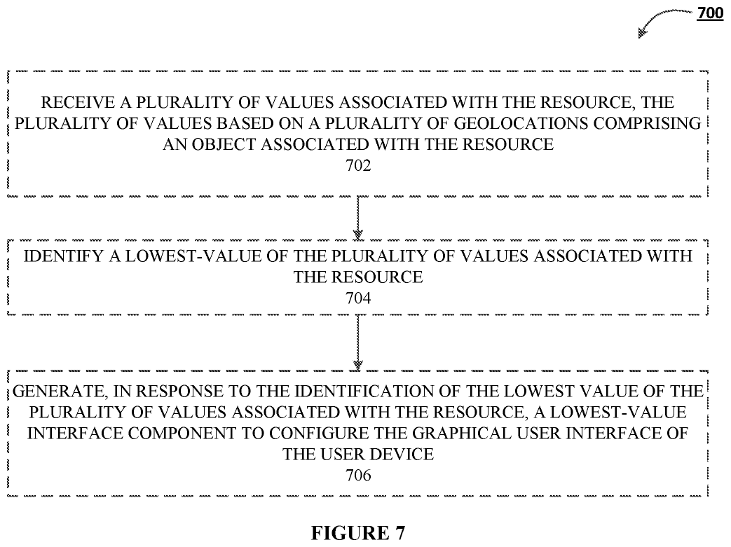

As shown in block 602, the process flow 600 may include the step of receiving, from the user device, an indication of a request for a real-time resource transaction, the real-time resource transaction comprising a real-time value of the resource. By way of non-limiting example, the real-time value of the resource may generally refer to the current value of the resource, such as the current amount requested by the specific entity for a resource transaction to be completed (e.g., the cost of the resource). In some embodiments, the real-time resource transaction may comprise a real-time value of the resource at the specific entity location or a real-time value at different specific entity locations. In some embodiments, the real-time value of the resource may comprise a lowest-value of the resource, which is described in further detail below with respect to FIG. 7.

As shown in block 604, the process flow 600 may include the step of completing the request for the real-time resource transaction. By way of non-limiting example, the resource availability system, upon identifying the real-time value of the resource, may complete a resource transaction for the user after the user has indicated an intention to complete the resource transaction based on the real-time value. Such a real-time transaction may occur based on an indication provided by the user device and transmitted to the resource availability system via a network. In some embodiments, the resource transaction may occur with or without the resource currently being in inventory in the specific entity location, such that the resource transaction occurs even if the user is not in physical possession of the resource. For instance, a user may purchase the resource via the real-time transaction and identify a geolocation for the resource to be shipped to and from, and may use the real-time value of the resource in the resource transaction, such that the resource does not need to have a resource transaction at a later time and at a potentially higher real-time value. For instance, the user does not have to wait for the resource to be in inventory at the specific entity location to complete a resource transaction, especially if this means that to wait until the resource is physically in the specific entity location means the resource could potentially be associated with a higher value (e.g., cost).

FIG. 7 illustrates a process flow 700 for generating a lowest-value interface component to configure the graphical user interface of the user device, in accordance with an embodiment of the invention. In some embodiments, a system (e.g., similar to one or more of the systems described herein with respect to FIGS. 1A-1C) may perform one or more of the steps of process flow 700. For example, a resource availability system (e.g., the system 130 described herein with respect to FIG. 1A-1C) may perform the steps of process 700.

As shown in block 702, the process flow 700 may include the step of receiving a plurality of values associated with the resource, the plurality of values based on a plurality of geolocations comprising an object associated with the resource. By way of non-limiting example, the plurality of values may generally refer to different values and/or costs of the resources (e.g., the products associated with the resource identifier) in different specific entity locations which may all be located in different geolocations (e.g., different towns, cities, states, and/or countries).

As shown in block 704, the process flow 700 may include the step of identifying a lowest-value of the plurality of values associated with the resource. By way of non-limiting example, the lowest-value of the plurality of values may generally refer to the lowest cost of the resource (e.g., the products associated with the resource identifier) in the different specific entity locations, such that a lowest cost of the resource is identified out of the plurality of values.

In some embodiments, the resource availability system may also identify other values in a specific area or range from the specific entity location (e.g., such as a range of miles away from the specific entity location associated with the user device) and select the lowest value from the plurality of values. In this manner, the user may complete a resource transaction for an object of the resource (e.g., a product associated with the resource) that is located a shorter distance than other resources associated with the resource identifier which could potentially be at a lower value (e.g., out of the country and/or across the country from the user device) that may take longer to get to be shipped to the user.

In some embodiments, the resource availability system may identify the lowest value of the resource and may allow the user to select the lowest-value for the resource. The resource availability system may still send the closest resource associated with the resource identifier to the user such that the identification of the lowest-value comprises a price-matching.

As shown in block 706, the process flow 700 may include the step of generating, in response to the identification of the lowest value of the plurality of values associated with the resource, a lowest-value interface component to configure the graphical user interface of the user device. By way of non-limiting examples, the lowest value of the resource is used to generate the lowest-value interface component, which in turn may be transmitted by the resource availability system to configure the GUI of the user device. In some embodiments, the lowest-interface component may further identify the lowest-value in certain geographic ranges from the user and/or within certain geographic regions (e.g., within the state, within the region of the country (northeast, midwest, northwest, west, south, southeast, and/or the like), within the country of the user, and/or the like), which may allow the user to identify specific regions that have the resource in inventory to complete a resource transaction. For instance, the lowest-value interface component may show the user of the user device a plurality of selections the user may make to choose the resource and its value, which may give the user the opportunity to choose a lowest-value of the resource based on specific regions such as a region near the user device (e.g., within 100 miles, within 200 miles, within 300 miles, within 400 miles, within 500 miles, and/or the like).

FIG. 8 illustrates a process flow 800 for dynamically updating the specified entity resource geolocation interface component with the real-time inventory tracker data, in accordance with an embodiment of the invention. In some embodiments, a system (e.g., similar to one or more of the systems described herein with respect to FIGS. 1A-1C) may perform one or more of the steps of process flow 800. For example, a resource availability system (e.g., the system 130 described herein with respect to FIG. 1A-1C) may perform the steps of process 800.

As shown in block 802, the process flow 800 may include the step of identifying a real-time resource amount within the specific entity location, wherein the real-time resource amount is based on real-time inventory tracker data of the resource within the specific entity. By way of non-limiting example, the real-time resource amount may generally refer to a current and/or real-time inventory amount of the resource in the specific entity location, a different specific entity location, and/or a general entity location (e.g., an inventory amount in various specific entity locations as a total amount of the resources that is specific entity wide, such as across all of the specific entity locations). In some embodiments, the real-time resource amount is based on the real-time inventory tracker data of the resource, wherein the real-time inventory tracker data may be based on the resources as the resources are brought into the specific entity's various locations and as the resources are sold at the specific entity's various locations, in real-time. By way of non-limiting example, the resource availability system may track the inventory at each specific entity location by tracking inventory accounts as it is updated with new inventory and tracking resources as they are bought in store and online. In some embodiments, the resource availability system may also track the resources as the resources are added to carts, both physical carts within a specific entity location and online carts within online stores. In some embodiments, the inventory tracking may occur based on resource identification by the resource availability system using cameras within the specific entity locations which are trained to identify the resources.

As shown in block 804, the process flow 800 may include the step of dynamically updating the specified entity resource geolocation interface component with the real-time inventory tracker data. By way of non-limiting example, the dynamic updating of the specified entity resource geolocation interface component may indicate the inventory as it changes throughout the specific entity, in real-time. In some embodiments, the specified entity resource geolocation interface component may comprise a count-down interface component of resources within the specific entity and its various specific entity locations, such that the count-down interface component shows how many resources are left in the various specific entity locations.

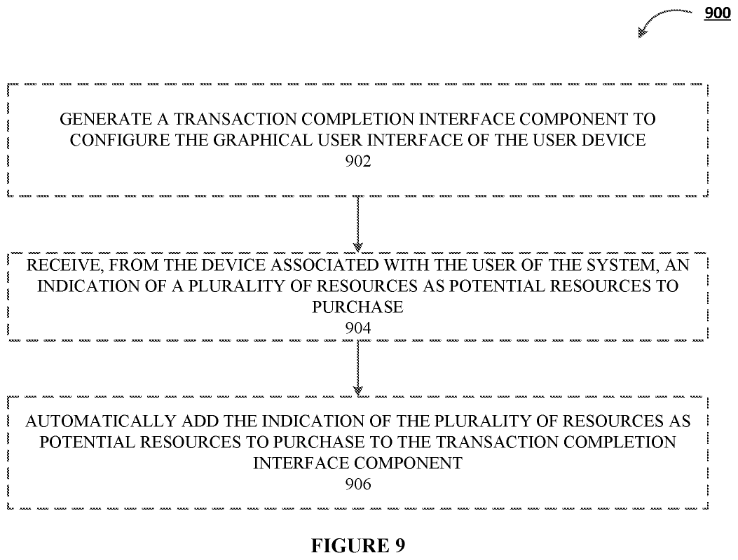

FIG. 9 illustrates a process flow 900 for automatically adding the indication of the plurality of resources as potential resources to purchase to the transaction completion interface component, in accordance with an embodiment of the invention. In some embodiments, a system (e.g., similar to one or more of the systems described herein with respect to FIGS. 1A-1C) may perform one or more of the steps of process flow 900. For example, a resource availability system (e.g., the system 130 described herein with respect to FIG. 1A-1C) may perform the steps of process 900.

As shown in block 902, the process flow 900 may include the step of generating a transaction completion interface component to configure the graphical user interface of the user device. By way of non-limiting example, the transaction completion interface component may generally be based on a transaction completion of the resource transaction which may be an indication transmitted by the resource availability system to the user device to configure the GUI of the user device. In some embodiments, the transaction completion interface component may indicate an option to the user to complete a transaction with the user-selected value of the resource (e.g., such as a lowest-value of the resource if the resource has been selected by the user) or a value of the resource at the specific entity location associated with the user device.

In some embodiments, the transaction completion interface component may comprise additional resources that may be selected by the user to immediately complete a resource transaction (e.g., such as a plurality of other resources based on a plurality of other resource identifiers).

As shown in block 904, the process flow 900 may include the step of receiving, from the user device, an indication of a plurality of resources as potential resources to purchase. By way of non-limiting example, the resource availability system may receive from the user device an indication of a plurality of resources (e.g., resource identifiers) as potential resources to purchase. In some embodiments, the transaction completion interface component may comprise an input field for the user to input a resource identifier to search within the resource database for selection of the resource in the transaction completion interface to complete a resource transaction. For instance, a user may input a plurality of resource identifiers (e.g., such as the natural names of the resources like the product names, manufacturer names, trademark names, and/or the like) to query the resource database in the resource availability system, then based on the results of the query, the resource availability system may return a list of potential resources the user may wish to purchase that has the same resource identifier from the plurality of resource identifiers and/or is linked within the resource availability system as being similar to the searched resource identifier (e.g., a similar product to the one intended by the user). Once this list of potential resources is shown to the user, the user may select from the list a potential resource to buy through the transaction completion interface.

In some embodiments, the indication of the plurality of resources as potential resources to purchase may be generated by the resource availability system which may base its determination on previous resource transactions completed by the same user, previous resource transactions completed by other users in the same specific entity location, and/or previous resource transactions completed by other users in the same region (e.g., the same town, city, region of state, and/or state). In this manner, the resource availability system may identify previous transactions completed by users and generate a list of potential resources that the current user may be interested in. For instance, if the current user previously bought a product such as milk, then the resource availability system may identify a potential resource for the current transaction to be milk. Additionally, or alternatively, if many users in the same specific entity location and/or in the same region previously bought specific products such as snow shovels which may indicate a winter storm, then the resource availability system may identify a snow shovel as a potential resource to the current user.

In some embodiments, and once a list of potential resources has been identified by the resource availability system which are associated with a resource identifier, the resource availability system may query the resource database of the specific entity location associated with the user device and determine whether any of the potential resources are currently in inventory at the specific entity location. In some embodiments, and if none of the potential resources are in inventory in the specific entity location, the resource availability system may query the resource database to determine if the potential resources are in inventory in different specific entity locations (e.g., different stores, warehouses, manufacturers, and/or the like).

As shown in block 906, the process flow 900 may include the step of automatically adding the indication of the plurality of resources as potential resources to purchase to the transaction completion interface component. By way of non-limiting example, the resource availability system may automatically add the indication of potential resources to the transaction completion interface component in order to complete the transaction of the potential resources. In some embodiments, the automatic adding of the potential resources may only occur if the resource identifiers of the potential resources match the resource identifiers input and/or selected by the user. In some embodiments, once the list of potential resources has been uploaded to the resource availability system by the user device, then the list of potential resources (e.g., after being used to query the resource database and after being determined to be in inventory at the specific entity location or at a different entity location), the potential resources may be automatically added to the transaction completion interface component at the current and/or lowest-value of each resource of the potential resources selected. In this manner, the user may complete the resource transaction using the current and/or lowest value for each of the resources of the selected potential resources instead of having to wait for the resource to be in inventory at the specific entity location and potentially having the resource comprise a higher value.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for determining an availability of a resource in a specific entity network, the system comprising:
at least one memory device with computer-readable program code stored thereon;
at least one processing device operatively coupled to the at least one memory device and at least one communication device, wherein executing the computer-readable program code is configured to cause the at least one processing device to:
identify a specific entity location associated with a user device;
scan a readable indicia to identify a resource identifier associated with a specific entity;
determine a physical unavailability of a resource associated with the resource identifier within the specific entity location;
determine a location of the resource to be at a different location from the specific entity location;
determine a period for the resource associated with the resource identifier to reach a geolocation identified by a user of the system, wherein the geolocation identified by the user comprises at least one of a shipping location identified by the user;
generate, in response to the determination of the resource at the different location from the specific entity location, an availability of a resource user interface component to configure a graphical user interface of the user device based on the shipping location identified by the user;
receive, from the user device, an indication of a request for a real-time resource transaction, the real-time resource transaction comprising a real-time value of the resource associated with the resource; and
complete the request for the real-time resource transaction comprising the real-time value of the resource.

2. The system of claim 1, wherein the processing device is further configured to:
generate a period interface component to configure the graphical user interface of the user device, the period interface component comprising data of the period for the resource associated with the resource identifier to reach the geolocation identified by the user.

3. The system of claim 2, wherein the geolocation identified by the user comprises at least one of a user's residential location or the location associated with the user device.

4. The system of claim 1, wherein the determination of the period for the resource associated with the resource identifier to reach the geolocation identified by the user comprises querying a resource database of the specific entity to determine a current availability of a plurality of objects associated with the resource identifier.

5. The system of claim 1, wherein the geolocation identified by the user is the specific entity location associated with the user device.

6. (canceled)

7. The system of claim 1, wherein the processing device is further configured to:
receive a plurality of values associated with the resource, the plurality of values based on a plurality of geolocations comprising an object associated with the resource;
automatically identify a lowest-value of the plurality of values associated with the resource; and
generate, in response to the identification of the lowest-value of the plurality of values associated with the resource, a lowest-value interface component to configure the graphical user interface of the user device, wherein the lowest-value interface component comprises data of the identified lowest-value of the plurality of values of the resource as a selected value of the resource for the real-time resource transaction.

8. The system of claim 1, wherein the processing device is further configured to:
determine, based on the identification of the resource identifier, a specified entity resource geolocation to be within the specific entity location, the specified entity resource geolocation comprising at least one of a specified aisle, a specified shelf, or a specified department within the specific entity location; and
generate, in response to the determination of the specified entity resource geolocation, a specified entity resource geolocation interface component to configure the graphical user interface of the user device.

9. The system of claim 8, wherein the processing device is further configured to:
identify a real-time resource amount within the specific entity location, wherein the real-time resource amount is based on real-time inventory tracker data of the resource within the specific entity location; and
dynamically update the specified entity resource geolocation interface component with the real-time inventory tracker data, wherein the specified entity resource geolocation interface component comprises a real-time resource amount of the resource for an at least one different location comprising the resource at a current time.

10. The system of claim 1, wherein the processing device is further configured to:
generate a transaction completion interface component to configure the graphical user interface of the device associated with the user of the system;
receive, from the user device, an indication of a plurality of resources as potential resources to purchase; and
automatically add the indication of the plurality of resources as potential resources to purchase to the transaction completion interface component.

11. The system of claim 1, wherein the processing device is further configured to:
generate, in response to the determination that the location of the resource to be at the location different from the specific entity location, a general entity resource geolocation interface component to configure the graphical user interface of the user device.

12. A computer program product for determining an availability of a resource in a specific entity network, wherein the computer program product comprises at least one non-transitory computer-readable medium having computer-readable program code portions embodied therein, the computer-readable program code portions which when executed by a processing device are configured to cause the processing device to:
identify a specific entity location associated with a user device;
scan readable indicia to identify a resource identifier associated with a specific entity;
determine a physical unavailability of a resource associated with the resource identifier within the specific entity location;
determine a location of the resource to be at a different location from the specific entity location;
determine a period for the resource associated with the resource identifier to reach a geolocation identified by a user of the system, wherein the geolocation identified by the user comprises at least one of a shipping location identified by the user;
generate, in response to the determination of the resource at the different location from the specific entity location, an availability of a resource user interface component to configure a graphical user interface of the user device based on the shipping location identified by the user;
receive, from the user device, an indication of a request for a real-time resource transaction, the real-time resource transaction comprising a real-time value of the resource associated with the resource; and
complete the request for the real-time resource transaction comprising the real-time value of the resource.

13. The computer program product of claim 12, wherein the processing device is further configured to cause the processing device to:
generate a period interface component to configure the graphical user interface of the user device, the period interface component comprising data of the period for the resource associated with the resource identifier to reach the geolocation identified by the user.

14. The computer program product of claim 12, wherein the geolocation identified by the user comprises at least one of a user's residential location, the location associated with the processing device, or a shipping location identified by the user.

15. The computer program product of claim 12, wherein the determination of the period for the resource associated with the resource identifier to reach the geolocation identified by the user comprises querying a resource database of the specific entity to determine current availability of a plurality of objects associated with the resource identifier.

16. (canceled)

17. A computer-implemented method for determining an availability of a resource in a specific entity network, the computer-implemented method comprising:
identifying a specific entity location associated with a user device;
scanning readable indicia to identify a resource identifier associated with a specific entity;
determining a physical unavailability of a resource associated with the resource identifier within the specific entity location;
determining a location of the resource to be at a different location from the specific entity location;
determining a period for the resource associated with the resource identifier to reach a geolocation identified by a user of the system, wherein the geolocation identified by the user comprises at least one of a shipping location identified by the user;
generating, in response to the determination of the resource at the different location from the specific entity location, an availability of a resource user interface component to configure a graphical user interface of the user device based on the shipping location identified by the user;
receiving, from the user device, an indication of a request for a real-time resource transaction, the real-time resource transaction comprising a real-time value of the resource associated with the resource; and
completing the request for the real-time resource transaction comprising the real-time value of the resource.

18. The computer-implemented method of claim 17, the computer-implemented method further comprising:
generating a period interface component to configure the graphical user interface of the user device, the period interface component comprising data of the period for the resource associated with the resource identifier to reach the geolocation identified by the user.

19. The computer-implemented method of claim 17, wherein the geolocation identified by the user comprises at least one of a user's residential location or the location associated with the processing device.

20. The computer-implemented method of claim 17, wherein the determination of the period for the resource associated with the resource identifier to reach the geolocation identified by the user comprises querying a resource database of the specific entity to determine current availability of a plurality of objects associated with the resource identifier.

21. The system of claim 9, wherein the real-time resource amount is based on a tracking of at least one resource associated with the resource identifier as the at least one resource is added to an inventory in at least one location and as the at least one resource are sold in the at least one location.

22. The system of claim 10, wherein the transaction completion interface component comprises the plurality of resources as potential resources to purchase, and the plurality of potential resources to purchase comprise a plurality of other resource identifiers, wherein the plurality of potential resources are similar to the resource associated with the resource identifier, and wherein the plurality of resources are available at a current time.
